(19) United States
(12) Patent Application Publication
(10) Pub. No.: US 2023/0311265 A1
(43) Pub. Date: Oct. 5, 2023

(54) KITCHEN ARTICLE AND METHODS

(71) Applicant: Robert T. Williams, New Port Richey, FL (US)

(72) Inventor: Robert T. Williams, New Port Richey, FL (US)

(21) Appl. No.: 18/128,899

(22) Filed: Mar. 30, 2023

Related U.S. Application Data
(60) Provisional application No. 63/327,502, filed on Apr. 5, 2022.

(51) Int. Cl. B24B 3/54; A47J 47/16

(52) U.S. Cl. CPC B24B 3/54; A47J 47/16; A47J 2201/00

(57) ABSTRACT

The present application discloses a kitchen article and methods of making and using the same. The kitchen article comprises a knife sharpening bar, a drill driver, and two return closed café rod brackets, the brackets are configured for receiving the knife sharpening bar, the sharpening bar is configured for mounting into the electric drill driver, the café rod brackets are configured for mounting in a horizontal line to a kitchen cabinet or wall, and the knife sharpening bar is configured for insertion into the cafe rod brackets to form a towel bar.

### CROSS-REFERENCE TO RELATED APPLICATION

This application claims the benefit U.S. provisional application No. 63/327,502, filed Apr. 5, 2022, the teaching of which is incorporated herein by reference in its entirety.

### FIELD OF THE INVENTION

The present invention relates to a kitchen article and methods of making and use thereof. In particular, the kitchen article is a combination of a knife sharpener and towel bar.

### BACKGROUND OF THE INVENTION

As population ages, the accessibility and ease of use of kitchen articles become an issue, especially for the population with a degree of physical limitation. Standard kitchen knife sharpeners are either difficult to use (requiring training and practice) or they are hidden out of the way in a drawer and do not provide a quick and easy way to properly sharpen kitchen knives.

Normal kitchen knife sharpeners are hard to use or inconvenient to use. Simple kitchen knife sharpeners are normally stored out of sight and are hard to find when needed. A professional kitchen knife sharpening bar takes practice to learn how to properly use. A “wet-stone” also take practice and is messy to use. The disclosed kitchen article provides a knife sharpener that is easy and convenient.

Other devices are either too hard to learn to use or are hidden away in a drawer or storage area. Simple devices do not do a good job of sharpening.

Standard sharpening bars require a technique that take practice to learn how to use to get a good edge on a kitchen knife. “Wet-stones” take practice and are messy and cumbersome. Simple devices simply do not do a good job of sharpening a kitchen knife.

Therefore, there is a need to provide kitchen articles that are readily accessible with an ease of use.

The embodiments provided below address the above identified issues and needs.

### SUMMARY OF THE INVENTION

In one aspect of the present invention, it is provided a kitchen article, the kitchen article comprising a knife sharpening bar, a drill driver, and two return closed café rod brackets, wherein the brackets are configured for receiving the knife sharpening bar,
wherein the sharpening bar is configured for mounting into the drill driver,
wherein the café rod brackets are configured for mounting in a horizontal line to a kitchen cabinet or wall, and
wherein the knife sharpening bar is configured for insertion into the cafe rod brackets to form a towel bar.

In some embodiments of the disclosed kitchen article, optionally in combination of various embodiments of the disclosed kitchen article herein, the drill driver is an electric drill driver.

In some embodiments of the disclosed kitchen article, optionally in combination of various embodiments of the disclosed kitchen article herein, the drill driver is powered by a battery.

In some embodiments of the disclosed kitchen article, optionally in combination of various embodiments of the disclosed kitchen article herein, the battery is a rechargeable battery.

In some embodiments of the disclosed kitchen article, optionally in combination of various embodiments of the disclosed kitchen article herein, the size is 1½ inches, and the diameter is ½ inches.

In some embodiments of the disclosed kitchen article, optionally in combination of various embodiments of the disclosed kitchen article herein, the knife sharpening bar is a standard kitchen carbon steel sharpening bar without handle.

In some embodiments of the disclosed kitchen article, optionally in combination of various embodiments of the disclosed kitchen article herein, the battery is rechargeable via a USB wall charger.

In another aspect of the present invention, it is provided a method of fabrication, comprising providing a design of a kitchen article and forming the kitchen article, the kitchen article comprising a knife sharpening bar, a drill driver, and two return closed café rod brackets, wherein the brackets are configured for receiving the knife sharpening bar,
wherein the sharpening bar is configured for mounting into the drill driver,
wherein the café rod brackets are configured for mounting in a horizontal line to a kitchen cabinet or wall, and
wherein the knife sharpening bar is configured for insertion into the cafe rod brackets to form a towel bar.

In some embodiments of the disclosed method, optionally in combination of various embodiments of the disclosed kitchen article herein, the drill driver is an electric drill driver.

In some embodiments of the disclosed method, the drill driver is powered by a battery.

In some embodiments of the disclosed method, the battery is a rechargeable battery.

In some embodiments of the disclosed method, the size is 1½ inches, and the diameter is ½ inches.

In some embodiments of the disclosed method, the knife sharpening bar is a standard kitchen carbon steel sharpening bar without handle.

In some embodiments of the disclosed method, the battery is rechargeable via a USB wall charger.

### BRIEF DESCRIPTION OF THE DRAWINGS

FIGS. 1A-1C show various views of embodiments of the disclosed kitchen article.

FIG. 2 shows a method of using an embodiment of the disclosed kitchen article.

### DETAILED DESCRIPTION OF THE INVENTION

### Definitions

As used herein, the term “standard” refers to a kitchen article that is currently commercially available or can be readily constructed according to specifications similar to the ones that are commercially available.

### Kitchen Article

In one aspect of the present invention, it is provided a kitchen article, the kitchen article comprising a knife sharpening bar, a drill driver, and two return closed café rod brackets, wherein the brackets are configured for receiving the knife sharpening bar,
wherein the sharpening bar is configured for mounting into the drill driver,
wherein the café rod brackets are configured for mounting in a horizontal line to a kitchen cabinet or wall, and
wherein the knife sharpening bar is configured for insertion into the cafe rod brackets to form a towel bar.

In some embodiments of the disclosed kitchen article, optionally in combination of various embodiments of the disclosed kitchen article herein, the drill driver is an electric drill driver.

In some embodiments of the disclosed kitchen article, optionally in combination of various embodiments of the disclosed kitchen article herein, the drill driver is powered by a battery.

In some embodiments of the disclosed kitchen article, optionally in combination of various embodiments of the disclosed kitchen article herein, the battery is a rechargeable battery.

In some embodiments of the disclosed kitchen article, optionally in combination of various embodiments of the disclosed kitchen article herein, the size is 1½ inches, and the diameter is ½ inches.

In some embodiments of the disclosed kitchen article, optionally in combination of various embodiments of the disclosed kitchen article herein, the knife sharpening bar is a standard kitchen carbon steel sharpening bar without handle.

In some embodiments of the disclosed kitchen article, optionally in combination of various embodiments of the disclosed kitchen article herein, the battery is rechargeable via a USB wall charger.

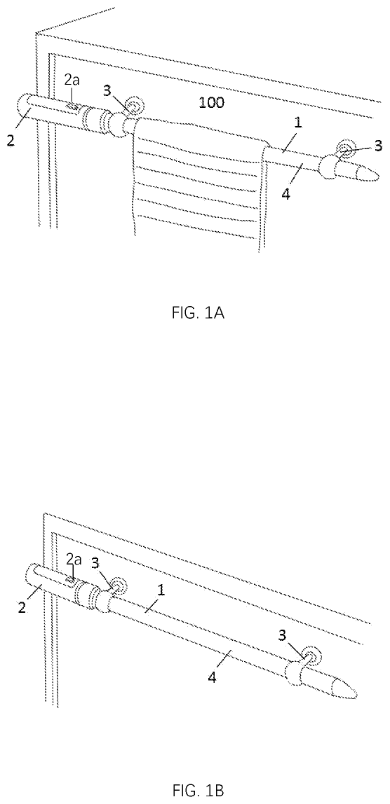

FIGS. 1A-1C show various embodiments of the disclosed kitchen article. In FIGS. 1A and 1B, a knife sharpener is shown being mounted on a cabinet, which also serves as a towel bar (FIG. 1C). Specifically, in FIGS. 1A and 1B, a kitchen article 100 is shown to have a knife sharpening bar 1, a drill driver 2, including an on/off switch 2a, two café rod brackets 3, the two café rod brackets being mounted onto a wall, the knife sharpening bar 1 is mounted to the two café rode brackets, forming a towel bar 4. In FIG. 1C, a knife sharpening bar 1 is shown to be mounted to a drill driver 2 with an on/off switch 2a, the knife sharpening bar 1 being disengaged from the two café rod brackets 3. The drill driver 2 is shown as being recharged via a USB wall charger 5, and the two café rod brackets are shown to have a size 3a. In this embodiment, the drill driver is powered by a re-chargeable battery. In some embodiments, the drill driver can be powered by AC or DC electricity or a non-rechargeable battery.

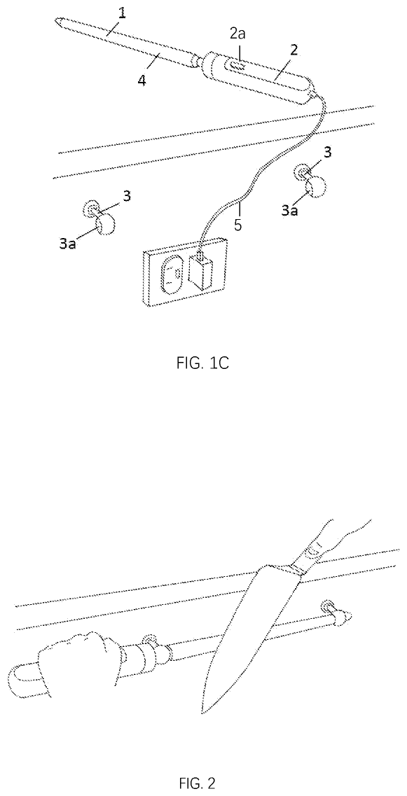

FIG. 2 shows a knife sharpening bar is mounted to a wall via two café rod brackets. A knife is being sharpened using the knife sharpening bar.

### Method of Fabrication

In another aspect of the present invention, it is provided a method of fabrication, comprising providing a design of a kitchen article and forming the kitchen article, the kitchen article comprising a knife sharpening bar, a drill driver, and two return closed café rod brackets, wherein the brackets are configured for receiving the knife sharpening bar,
wherein the sharpening bar is configured for mounting into the drill driver,
wherein the café rod brackets are configured for mounting in a horizontal line to a kitchen cabinet or wall, and
wherein the knife sharpening bar is configured for insertion into the cafe rod brackets to form a towel bar.

In some embodiments of the disclosed method, optionally in combination of various embodiments of the disclosed kitchen article herein, the drill driver is an electric drill driver.

In some embodiments of the disclosed method, the drill driver is powered by a battery.

In some embodiments of the disclosed method, the battery is a rechargeable battery.

In some embodiments of the disclosed method, the size is 1½ inches, and the diameter is ½ inches.

In some embodiments of the disclosed method, the knife sharpening bar is a standard kitchen carbon steel sharpening bar without handle.

In some embodiments of the disclosed method, the battery is rechargeable via a USB wall charger.

### Method of Use

The disclosed kitchen article makes it easy and convenient to sharpen kitchen knives. It is simple to use and can be permanently attached to a cabinet or wall close by in the kitchen area. When is not in use, the kitchen article doubles as a kitchen towel bar. The towel also hides the invention from plain sight and therefore blends into normal kitchen decor.

The kitchen article is easy to use and stays conveniently attached to a kitchen wall or cabinet.

The device is activated by the on/off switch on the electric driver and begins the spinning motion of the sharpening bar. This allows knives to be easily sharpened against the bar without the need to move the knife along the surface of the bar. One hand will activate the spinning motion with the on/off switch while the other places the knife against the spinning bar allowing for honing of the knifes edge (FIG. 2).

When needed the device can be removed from the cafe rod brackets to allow for free-hand sharpening or re-charging of the device batteries via USB charging adapter (FIG. 1C).

The sharpening action is simple and convenient and does not require special skills. The device allows a user to safely and conveniently keep their kitchen knives sharp, which is vital to a proper kitchen setting. The device stays inconspicuously hidden away disguised as a kitchen towel bar when not in use as a knife sharpener. It is easy to use and does not require special training or practice.

The kitchen article is a combination of a standard carbon steel kitchen knife sharpening bar and a standard battery (rechargeable) electric driver. This device is mounted on a wall or kitchen cabinet (by cafe rod holders) allowing easy access (FIGS. 1A and 1B). It then disguises itself as a kitchen towel bar when not in use (FIG. 1A). Manufacturing is simply a matter of combining these 3 standard items into one assembly.

The cafe rod holders could be deleted and the invention could be used as a hand-held device. However this would delete the feature of convenience and would no longer double as a kitchen towel bar.

Today's kitchen knife sharpeners are either hard to use (require training and practice) or they do not do a very good job of sharpening the kitchen knife. When needed, current kitchen knife sharpeners are usually stored away in an inconvenient location and are hard to find.

### EXAMPLES

The following examples are provided to illustrate, and not meant to limit, the scope of the invention disclosed herein.

FIGS. 1A-1C show embodiments of the disclosed kitchen article, which was designed and made according to the description herein.

FIG. 2 shows method of using the kitchen article disclosed herein.

It is understood that the foregoing detailed description and the following examples are illustrative only and are not to be taken as limitations upon the scope of the invention. Various changes and modifications to the disclosed embodiments, which will be apparent to those of skill in the art, may be made without departing from the spirit and scope of the present.

Those skilled in the art will know, or be able to ascertain, using no more than routine experimentation, many equivalents to the specific embodiments of the invention described herein. These and all other equivalents are intended to be encompassed by the following claims.

I claim:

1. A kitchen article, comprising a knife sharpening bar, a drill driver, and two return closed café rod brackets, wherein the brackets are configured for receiving the knife sharpening bar,
wherein the sharpening bar is configured for mounting into the drill driver,
wherein the café rod brackets are configured for mounting in a horizontal line to a kitchen cabinet or wall, and
wherein the knife sharpening bar is configured for insertion into the cafe rod brackets to form a towel bar.

2. The kitchen article according to claim 1, wherein the drill driver is an electric drill driver.

3. The kitchen article according to claim 2, wherein the drill driver is powered by a battery.

4. The kitchen article according to claim 3, wherein the battery is a rechargeable battery.

5. The kitchen article according to claim 2, wherein the size is 1½ inches, and the diameter is ½ inches.

6. The kitchen article according to claim 2, wherein the knife sharpening bar is a standard kitchen carbon steel sharpening bar without handle.

7. The kitchen article according to claim 3, wherein the battery is rechargeable via a USB wall charger.

8. A method of fabrication, comprising providing a design of a kitchen article and forming the kitchen article,
wherein the kitchen article comprises a knife sharpening bar, a drill driver, and two return closed café rod brackets,
wherein the brackets are configured for receiving the knife sharpening bar,
wherein the sharpening bar is configured for mounting into the drill driver,
wherein the café rod brackets are configured for mounting in a horizontal line to a kitchen cabinet or wall, and
wherein the knife sharpening bar is configured for insertion into the cafe rod brackets to form a towel bar.

9. The method according to claim 8, wherein the drill driver is an electric drill driver.

10. The method according to claim 9, wherein the drill driver is powered by a battery.

11. The method according to claim 10, wherein the battery is a rechargeable battery.

12. The method according to claim 9, wherein the size is 1½ inches, and the diameter is ½ inches.

13. The method according to claim 9, wherein the knife sharpening bar is a standard kitchen carbon steel sharpening bar without handle.

14. The method according to claim 10, wherein the battery is rechargeable via a USB wall charger.
